(19) United States
(12) Patent Application Publication
(10) Pub. No.: US 2019/0072063 A1
(43) Pub. Date: Mar. 7, 2019

(54) FLOW RESTRICTOR FOR AN INJECTOR

(71) Applicant: Robert Bosch GmbH, Stuttgart (DE)

(72) Inventor: Dieter Blatterer, Enns (AU)

(21) Appl. No.: 15/767,138

(22) PCT Filed: Aug. 11, 2016
(86) PCT No.: PCT/EP2016/069132

§ 371 Date: Apr. 9, 2018

(30) Foreign Application Priority Data
Oct. 15, 2015 (DE) 10 2015 220 028.0

(51) Int. Cl. F02M 63/00; F02M 63/02; F16K 15/04

(52) U.S. Cl. CPC F02M 63/0054; F02M 63/0215; F02M 55/025; F02M 2200/18; F02M 2200/40; F16K 15/044

(57) ABSTRACT

The invention relates to a flow restrictor (16) for an injector of a common rail fuel injection system. The flow restrictor (16) has a closure bolt (5) with a high-pressure connection (20), a valve housing (24), a ball (15), and a spring (17). A support seat (28) is formed on the closure bolt (5), and a valve seat is formed on the valve housing (24). The ball (15) is arranged in an axial bore (11a) formed in the valve housing (24) and is acted upon by the spring (17) in the direction of the support seat (28). Upon contacting the support seat (28), the ball (15) releases a hydraulic connection of the high-pressure connection (20) through the axial bore (11a), and upon contacting the valve seat (18), the ball blocks the hydraulic connection. The support seat (28) has an oval contour.

### BACKGROUND OF THE INVENTION

The invention relates to a flow restrictor for an injector of a common rail fuel injection system, in particular a modular common rail fuel injection system.

A characteristic features of modular common rail fuel injection systems for internal combustion engines is that some of the storage volume that exists in the system is present in the injector itself. Modular common rail fuel injection systems are used on particularly large engines in which the individual injectors are possibly fitted at a considerable distance from one another. Using just one common rail for all injectors is not appropriate on such engines, since during injection the long fuel lines would result in a massive drop in the fuel injection pressure, so that over a prolonged injection period the fuel injection rate would fall markedly. One proposal on such engines, therefore, is to arrange a high-pressure accumulator inside each injector. Such a design is referred to as a modular construction, since each individual injector has its own high-pressure accumulator and can therefore be used as an independent module. Rather than a conventional fuel rail, the term “high-pressure accumulator” here is taken to mean a pressure-resistant vessel having a feed line and a discharge line, and the diameter of which is significantly enlarged compared to the high-pressure lines, in order that a certain fuel injection quantity can be delivered from the high-pressure accumulator without sustaining an immediate drop in pressure.

High-pressure fuel from a high-pressure pump is fed to the injectors of modular common rail systems, the fuel usually being fed via an orifice of the injector on the top of the high-pressure accumulator (so-called top feed); alternatively the feed may also be applied laterally (side feed). The high-pressure line carrying the high-pressure fuel here is connected to the injector via a closure bolt of a flow restrictor provided with a high-pressure connection. As a rule, the closure bolt has the further function of conducting the fuel for the adjacent injectors, for which purpose a second high-pressure connection is provided.

When the rate of flow is too high, the flow restrictor separates the injector from the high-pressure fuel supply, in order to prevent the injector continuously injecting fuel into the combustion chamber of the internal combustion engine. Such a flow restrictor is disclosed, for example, by EP 2 662 557 A1.

The known flow restrictor for an injector of a common rail fuel injection system comprises a closure bolt having a high-pressure connection, a valve housing, a ball and a spring. A contact seat is formed on the closure bolt and a valve seat on the valve housing. The ball is located in an axial bore formed in the valve housing and is acted upon by the spring in the direction of the contact seat. When it rests on the contact seat the ball opens a hydraulic connection from the high-pressure connection through the axial bore, and when it rests on the valve seat it blocks the hydraulic connection. In the assembled state of the restrictor, the hydraulic connection opens downstream into a high-pressure accumulator of the injector.

Operation of the injector leads to much repeated contact between the ball and the contact seat and consequently also to wear. The hydraulic connection must remain opened when the ball is resting on the contact seat; this is ensured, for example, by grooves or recesses in the axial bore. This makes the contour of the contact seat very sharp-edged and therefore also susceptible to wear.

### SUMMARY OF THE INVENTION

The flow restrictor according to the invention, by contrast, has an improved wear performance, because the peak contact pressures between the ball and the contact seat are reduced. The service life of the flow restrictor is thereby increased. Furthermore, malfunctions due to wear particles on the flow restrictor and on the injector are avoided.

For this purpose the flow restrictor comprises a closure bolt with a high-pressure connection, a valve housing, a ball and a spring. A contact seat is formed on the closure bolt and a valve seat on the valve housing. The ball is located in an axial bore formed in the valve housing and is acted upon by the spring in the direction of the contact seat. When it rests on the contact seat the ball opens a hydraulic connection from the high-pressure connection through the axial bore, and when it rests on the valve seat it blocks the hydraulic connection. According to the invention the contact seat has an oval contour.

The oval contour serves to reduce the peak contact pressures between the ball and the contact seat. At the same time the hydraulic connection through the axial bore remains opened when the ball rests on the contact seat, thereby fulfilling a bypass function. In addition, the oval contour is easier to produce, for example through erosion or laser machining, than a circular bore with recesses or grooves.

The contact seat advantageously has an elliptical contour. The peak contact pressures between the ball and the contact seat are thereby optimally minimized.

In advantageous embodiments a high-pressure bore is formed in the closure bolt, wherein the high-pressure bore opens into the contact seat and has an elliptical contour. The contact seat is thereby defined by the elliptical high-pressure bore or constitutes an edge of this high-pressure bore. The high-pressure bore is preferably produced by erosion or laser machining, so that the elliptical contour of the contact seat is easily produced.

In an advantageous development the spring is arranged in the axial bore. This gives the flow restrictor a particularly compact design, saving overall space. Here the spring is preferably supported on a shoulder of the axial bore.

The invention further comprises an injector for injecting fuel into the combustion chamber of an internal combustion engine, wherein the injector comprises an injector body and a flow restrictor as described above. The flow restrictor here is connected, for example fastened, to the injector body. This serves to prevent the injector continuously injecting fuel into the combustion chamber, which would constitute a serious safety hazard.

In an advantageous development the valve housing is fastened between the injector body and the closure bolt by means of a clamping nut, preferably so that it is media-tight. This gives the connection between the flow restrictor and the injector a compact design. At the same time the valve housing seals off this connection, so that fuel cannot get into the surroundings.

In advantageous embodiments a high-pressure accumulator is formed in the injector body, wherein the axial bore is hydraulically connected to the high-pressure accumulator. It is advantageous, especially on large internal combustion engines, to arrange a high-pressure accumulator directly in the injector, in order to have sufficient fuel available for injection. Long flow paths are thereby avoided and a large fall in fuel pressure during injection is prevented.

In advantageous developments the axial bore is connected to the high-pressure accumulator by way of a restriction. In order to allow a replenishing flow of fuel into the high-pressure accumulator whilst fuel is being injected into the combustion chamber of the internal combustion engine, and to prevent any interaction between the injection pressure or the fuel injection quantity of the individual injectors, the axial bore opens into the injector via the restriction, preferably formed in the valve housing. Arranging the restriction in the valve housing moreover affords the advantage that any adaptation of the restriction cross section to the particular requirements of the fuel injection system is easily done by exchanging the valve housing, without having to replace further components in order to achieve this.

An edge-type filter, which retains coarse particles from the fuel, is also preferably arranged in the valve housing.

### BRIEF DESCRIPTION OF THE DRAWINGS

The invention is explained in more detail below, referring to the drawings, in which:

FIG. 1 shows an embodiment of the flow restrictor in longitudinal section,

FIG. 2a shows the section A-A in FIG. 1 according to the prior art,

FIG. 2b shows the section A-A in FIG. 1 of the flow restrictor according to the invention.

### DETAILED DESCRIPTION

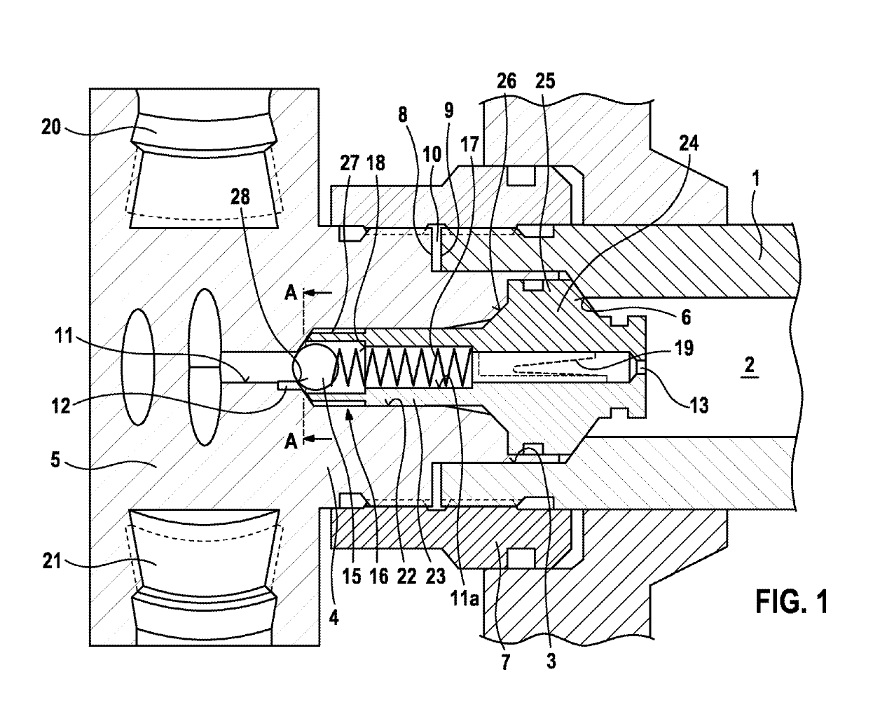

FIG. 1 represents an end portion of an injector body 1 of an injector, in which a high-pressure accumulator 2 is incorporated. The injector body 1 may also be referred to as a holder. The injector comprises a flow restrictor 16, wherein the flow restrictor 16 comprises a valve housing 24, an axial bore 11a formed in the valve housing 24, a ball 15 serving as closing element and located in the axial bore 11a, a valve seat 18 formed on the valve housing 24, and a contact seat 28.

The injector body or holder 1 has an orifice 3, which leads to the high-pressure accumulator 2 and into which a bolt-like portion 4 of a closure bolt 5 is introduced. The closure bolt 5 is screw-fastened to the injector body 1 by means of a clamping nut 7, wherein the clamping nut 7 interacts through its internal thread with external threads of the injector body 1 and the closure bolt 5 axially adjoining one another.

A high-pressure connection 20 and a further 20 high-pressure connection 21 are formed in the closure bolt 5. Connected to the high-pressure connection 20 is a line, not further represented, via which high-pressure fuel is delivered by a high-pressure pump, not represented. A connection to a succeeding injector can be made via the further high-pressure connection 21. A high-pressure bore 11, which is connected to the high-pressure connections 20, 21 and which leads in the direction of the injector body 1, is furthermore formed in the closure bolt 5. The high-pressure bore 11 has recesses 12, which do not run over the entire circumference of the high-pressure bore 11.

The bolt-like portion 4 of the closure bolt 5 has a locating bore 22, in which an axial portion 23 of the valve housing 24 is received. The valve housing 24 comprises a shoulder 25, on which a tapered sealing face 6 is formed in the direction of the injector body 1 and a further tapered sealing face 26 in the direction of the closure bolt 5. The sealing face 6 interacts with a corresponding mating face on the edge of the orifice 3 of the injector body. The further tapered sealing face 26 interacts with a conical mating face of the bolt-like portion 4. This means that screw-fastening the closure bolt 5 by means of the clamping nut 7 simultaneously generates a sealing force on the sealing face 6 and on the further sealing face 26. The required holding force or sealing force is thus adjusted by the clamping nut 7. A gap 10 is provided between a shoulder 8 of the closure bolt 5 and an annular end face 9 of the injector body 1, in order to avoid a double fit.

The axial bore 11a, which opens into the high-pressure bore 11, is formed in the valve housing 24, wherein the connection can be closed by the ball 15. An edge-type filter 19 is arranged and a restriction 13 is formed in the axial bore 11a. The axial bore 11a can be hydraulically connected to the high-pressure accumulator 2 via the restriction 13, wherein the edge-type filter 19 is arranged upstream of the restriction 13.

The ball 15 is furthermore located in the axial bore 11 a in the direction of the high-pressure bore 11. The ball 15 is acted upon in the direction of the high-pressure line 11 by a spring 17 arranged in the axial bore 11a, so that it interacts with the contact seat 28 formed on the closure bolt 15 or on the bolt-like portion 4. For this purpose the spring 17 is supported on a step of the axial bore 11a.

A contact surface 28a is formed on the closure bolt 5 and arranged so that it annularly surrounds the high-pressure bore 11. The contact seat 28 is thus formed at the transition of the contact surface 28a to the high-pressure bore 11, wherein the contact surface 28a tapers in the direction of the high-pressure bore 11.

The valve seat 18, which interacts with the ball 15, is formed on the axial portion 23 opposite the contact surface 28a. The ball can thus be moved between the contact seat 28 and the valve seat 18.

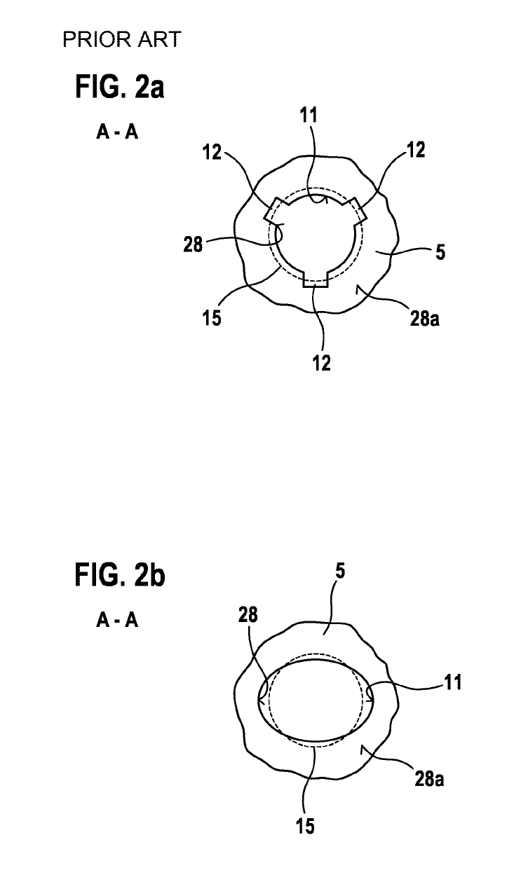

If the ball 15 rests on the contact seat 28 the hydraulic connection through the axial bore 11a—that is to say between the high-pressure bore 11 and the high-pressure accumulator 2—is opened. If the ball rests on the valve seat 18 it closes the hydraulic connection through the axial bore 11a. The configuration of the hydraulic connection by the contact surface 28a or the contact seat 28 is here represented in more detail in FIGS. 2a and 2b.

The end face of the axial portion 23 of the valve housing 24 terminates at a distance in front of the annular contact surface 28 provided at the transition of the locating bore 22 into the high-pressure bore 11. The axial portion 23 received in the locating bore 22 is furthermore formed with a reduced outside diameter in its front area 27, so that in the annular gap thereby produced between the outer circumference of the front area 27 of the axial portion 23 and the locating bore 22 the pressure of the high-pressure fuel is able to exert an external action on the front area 27. This leads to a pressure-balanced front area 27, so that the oscillation stress is reduced.

FIGS. 2a and 2b show the section A-A in FIG. 1, wherein FIG. 2a shows the embodiment according to the prior art and FIG. 2b shows the embodiment according to the invention.

FIG. 2a shows the formation of three recesses 12 in the closure bolt 5 as a radial widening of the high-pressure bore 11. The contact surface 28a is thus defined by the contour of the recesses 12 and the high-pressure bore 11 and together with these forms the contact seat 28. If the ball 15 rests on the contact seat 28, the hydraulic connection leads between the high-pressure bore 11 and the high-pressure accumulator 2 via the recesses 12; replenishing fuel can therefore flow into the high-pressure accumulator 2, since the recesses 12 fulfil a bypass function.

In the embodiment according to the invention in FIG. 2b the high-pressure bore 11 does not have any recesses 12 but instead has an elliptical cross-section; consequently the contact seat 28 also has an elliptical contour, which is formed by an edge of the high-pressure bore 11. Thus, here too, when the ball 15 rests on the contact seat 28, the hydraulic connection between the high-pressure bore 11 and the high-pressure accumulator 2 is opened, since the ball 15 is unable to close the ellipse completely; the bypass function is therefore maintained. An oval contour is also possible as an alternative to the elliptical contour of the contact seat 28.

The flow restrictor 16 functions as follows: in common rail systems, under unfavorable circumstances leakages can occur, whether in the rail system or due to defective injectors. An injector has a nozzle needle, which opens and closes the injection orifices of the injector into the combustion chamber of the internal combustion engine. An injector with a sticking nozzle needle, which leads to continuous injections of fuel into the combustion chamber, can cause considerable damage. This damage can lead to vehicle fires or to destruction of the engine. Flow rate restrictors with a closing function serve to prevent these hazards by closing the inlet to the injector affected if more than a maximum quantity of fuel is drawn from the high-pressure accumulator 2, and thereby isolating the high pressure on the injection-pump side from the injection valve and the nozzle needle.

In the operating state of the injector the ball 15 in the axial bore 11a is pressed onto the contact surface 28s, or more precisely into the contact seat 28; the hydraulic connection through the axial bore 11a between the high-pressure bore 11 and the high-pressure accumulator 2 is opened due to the oval cross section of the high-pressure bore 11 and the contact seat 28. In operation, the ball 15 moves in the direction of the valve seat 18 due to the flow generated during injection by virtue of the pressure differential as the flow passes around the ball. If the pressure in the high-pressure accumulator 2 falls too sharply, owing to a leakage or other malfunction, an excessive pressure differential occurs on the ball 15 between the side of the high-pressure bore 11 and the side of the axial bore 11a. In the event of an excessive pressure differential or if a maximum fuel injection quantity is exceeded, the ball 15 goes into the valve seat 18 and thus closes the hydraulic connection from the high-pressure bore 11 to the high-pressure accumulator 2; a further flow into the injector and hence any continuous injection is thereby prevented.

The oval, in particular elliptical shape of the high-pressure bore 11 and the contact seat 28 means that there are no more sharp edges in the contact between the ball 5 and the contact surface 28a on the contact seat 28, but at the same time the bypass function is maintained. Peak contact pressures between the contact seat 28 and the ball 15 are thus avoided, and the fatigue strength and hence the functional performance of the flow restrictor 16 are increased, along with that of the injector as a whole.

1. A flow restrictor (16) for an injector of a common rail fuel injection system, wherein the flow restrictor (16) comprises a closure bolt (5) having a high-pressure connection (20), and the flow restrictor also comprises a valve housing (24), a ball (15) and a spring (17), wherein a contact seat (28) is formed on the closure bolt (5), wherein a valve seat (18) is formed on the valve housing (24), wherein the ball (15) is located in an axial bore (11a) formed in the valve housing (24) and is acted upon by the spring (17) in a direction of the contact seat (28), wherein the ball (15), when the ball rests on the contact seat (28), opens a hydraulic connection from the high-pressure connection (20) through the axial bore (11a), and when the ball rests on the valve seat (18), the ball blocks the hydraulic connection, wherein the contact seat (28) has an oval contour.

2. The flow restrictor (16) as claimed in claim 1, characterized in that the contact seat (28) has an elliptical contour.

3. The flow restrictor (16) as claimed in claim 2, characterized in that a high-pressure bore (11) is formed in the closure bolt (5), wherein the high-pressure bore (11) opens into the contact seat (28) and has an elliptical contour.

4. The flow restrictor (16) as claimed in claim 1, characterized in that the spring (17) is arranged in the axial bore (11a).

5. An injector for injecting fuel into the combustion chamber of an internal combustion engine, wherein the injector comprises an injector body (1) and a flow restrictor (16) as claimed in claim 1, wherein the flow restrictor (16) is connected to the injector body (1).

6. The injector as claimed in claim 5, characterized in that the valve housing (24) is clamped between the injector body (1) and the closure bolt (5) by means of a clamping nut (7).

7. The injector as claimed in claim 5, characterized in that a high-pressure accumulator (2) is formed in the injector body (1), wherein the axial bore (11a) is hydraulically connected to the high-pressure accumulator (2).

8. The injector as claimed in claim 7, characterized in that the axial bore (11a) is connected to the high-pressure accumulator (2) by way of a restriction (13).
